(19) United States
(12) Patent Application Publication
(10) Pub. No.: US 2002/0167112 A1
(43) Pub. Date: Nov. 14, 2002

(54) Modified acrylic based compositions of enhanced optics and low temperature impact strength

(76) Inventors: Peter D. Colburn JR., Guilford, CT (US); Dimo K. Dimov, Branford, CT (US); Edward Capriles, Guilford, CT (US)

Correspondence Address: KLAUBER & JACKSON, 411 HACKENSACK AVENUE, HACKENSACK, NJ, 07601

(21) Appl. No.: 10/072,612

(22) Filed: Feb. 6, 2002

Related U.S. Application Data
(60) Provisional application No. 60/266,642, filed on Feb. 6, 2001.

(51) Int. Cl. B29C 47/00

(52) U.S. Cl. 264/211; 524/91; 524/523; 524/533

(57) ABSTRACT

Acrylic based multipolymer compositions having enhanced optical properties, comparable to impact modified PM resins, good sub-zero temperature impact strength similar to that of the Acrylic Based Multipolymer Compounds and improved weatherability, are disclosed. These compositions comprise a blend of an acrylic based multipolymer, comprising one or more of acrylonitrile, butyl acrylate, ethyl acrylate, methyl acrylate, methyl methacrylate, and styrene; a methylmethacrylate-butadiene-styrene (MBS) copolymer modifier polymerized by a free radical process; UV stabilizers, including benzotriazole derivatives, triazine derivatives, and hindered amine light stabilizers, as single components or combinations thereof; and one or more antioxidants, dyes and plasticizing flow enhancers. Both the compositions and their method of preparation are disclosed. The compositions are particularly useful for injection molding applications and the preparation of polymer films and sheets having improved optical and thermal properties, that are particularly suited for a variety of industrial applications.

### BACKGROUND OF THE INVENTION

1. Field of the Invention

The present invention relates to the preparation and use of acrylic based compounds for injection molding applications and the preparation of polymer films and sheets having improved optical and thermal properties, that are particularly suited for a variety of industrial applications.

2. Description of the Related Art

Polymethylmethacrylate (PMMA) resins are well known for their exceptional clarity and good weatherability and find applications such as automotive, glazing, packaging, etc. The impact properties of these polymers have been improved by blending butyl acrylate impact modifiers polymerized by free radical emulsion polymerization. However, impact modified PMMA resins generally possess relatively poor impact properties at sub-zero temperatures, thereby limiting their use in this temperature range.

Acrylic based multipolymer compounds, like Acrylite XT® polymer & CYROLITE® are impact modified with polybutadiene modifiers and retain high level of impact strength at substantially lower temperatures than the corresponding PMMA grades, i.e. −80° F. However, the optical properties of state of the art polybutadiene modified resins is deficient relative to the optics of PMMA resins.

Accordingly, a need exists for an improved class of resin compounds and compositions that offer improved thermal and optical properties and performance in a broad range of environmental conditions.

### SUMMARY OF THE INVENTION

The present invention provides acrylic based multipolymer compositions having enhanced optical properties, comparable to impact modified PMMA resins, good sub-zero temperature impact strength similar to that of the Acrylic Based Multipolymer Compounds, like XT® polymer & CYROLITE®, and improved weatherability. These compositions comprise a blend of:

A) an acrylic based multipolymer, comprising in weight %: 8-12% acrylonitrile, 3-8% butyl acrylate, 3-5% ethyl acrylate, 3-8% methyl acrylate, 65-80% methyl methacrylate, and 15-30% styrene.

B) a methylmethacrylate-butadiene-styrene (MBS) copolymer modifier polymerized by a free radical process.

C) commercially available UV stabilizers, including benzotriazole derivatives, triazine derivatives, and hindered amine light stabilizers, as single components or combinations thereof.

D) a combination of commercially available antioxidants, dyes and plasticizing flow enhancers.

In a particular embodiment, the composition comprises, in weight percent, from 55 to 85% of component A, from 15 to 45% of component B, up to about 0.5% of component C, and up to 5.0% of component D.

More particularly, the invention extends to such compositions displaying the combination of improved optical properties and sub-zero temperature stability, that are prepared by a method that includes the blending of components to achieve a Refractive Index (RI) that tolerates a maximum mismatch between components of 0.001 refractive index units.

In a further aspect, the invention relates to an acrylic based multipolymer composition wherein the auxiliary polymer additives have composition within the following range, in % by weight:

| | | |
|---|---|---|
| Formula A, Low refractive index: | methyl methacrylate | 92-98% |
| | methyl acrylate | 2-8% |
| Formula B, high refractive index | methyl methacrylate | 30-50% |
| | styrene | 45-70% |
| | acrylonitrile | 8-12% |
| | ethyl acrylate | 3-8% |

The inventive compositions may include up to 5% of lubricants, processing aids, and plasticisers. Further the compositions may contain up to 0.5% of UV stabilizers, and such stabilizers may in turn, comprise benzotriazole derivatives, including benzotriazole derivatives selected from the group consisting of 2-(2′-hydroxy-5′-methylphenyl) benzotriazole, triazine derivatives, e.g. 2-(4,6-diphenyl-1,3,5-triazine-2-yl)-5-hexyloxy)phenol, or hindered amine light stabilizers, and combinations thereof.

As stated above and herein, the compositions of of the invention exhibit the retention of room temperature impact strength tdo a commercially significant level at sub-zero temperatures, as low as −80° F. Accordingly, numerous formed products may be prepared that take advantage of the mechanical and optical properties exhibited by the present compositions.

Other objects and advantages will become apparent to those skilled in the art from a consideration of the detailed description that proceeds with reference to the following illustrative drawings.

### BRIEF DESCRIPTION OF THE DRAWINGS

FIGS. 1 and 2 and TEM micrographs of the impact modified acrylic based resin of Example 1.

### DETAILED DESCRIPTION OF THE INVENTION

The improved impact strength of the products is due to microphase separation of the polymer blend, the particle size of the rubber phase being a critical factor in control of the underlying fracture mechanics. A suitable particle size range is from at least about 50 nanometers (nm) and can be on the order of 100 nm or more.

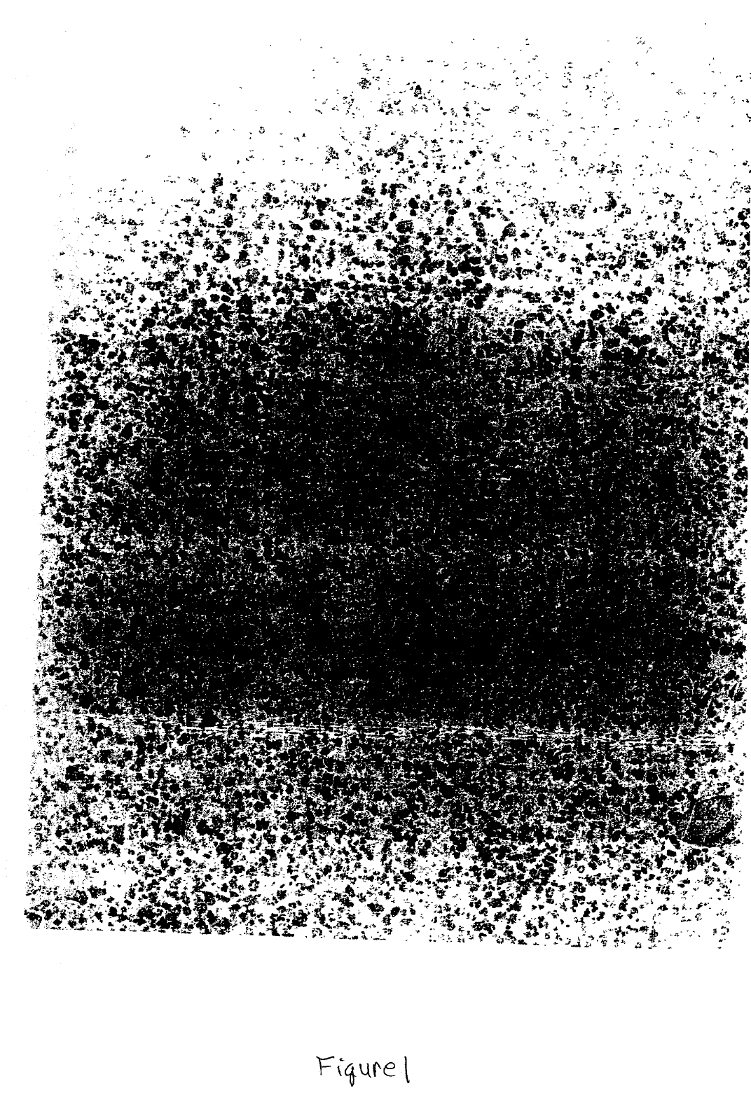

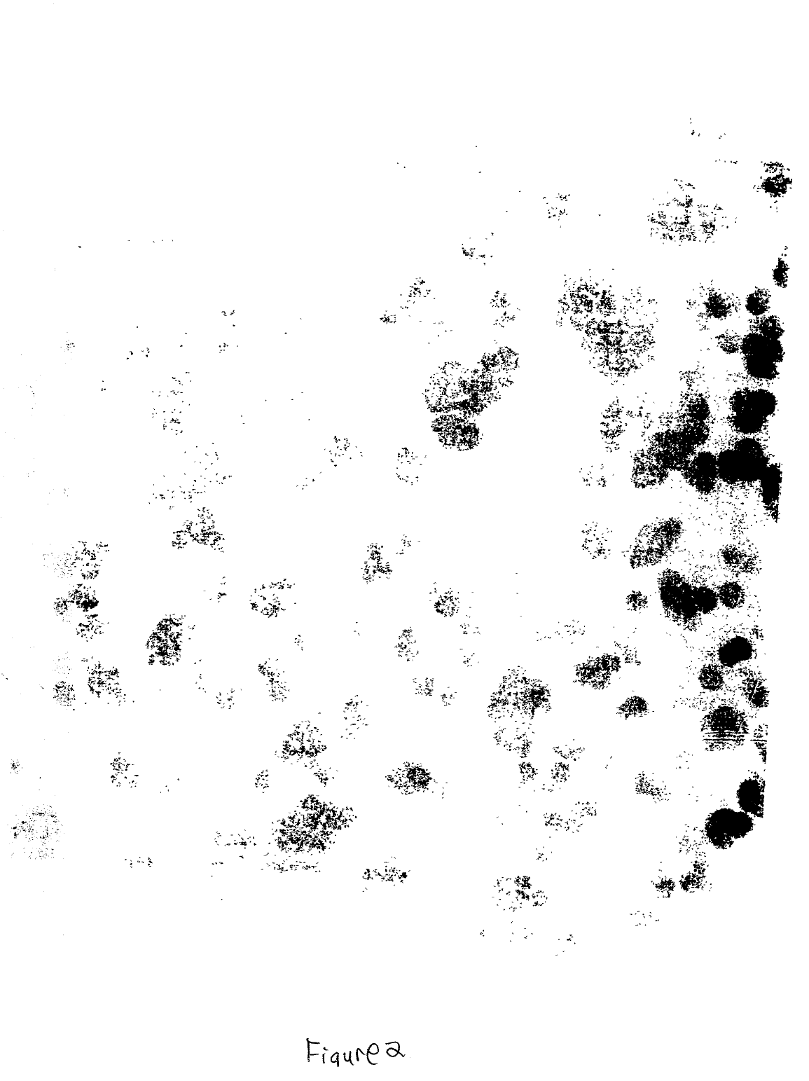

The small size modifier particles in the hard phase as seen in TEM micrographs (FIGS. 1 and 2), the good mechanical properties like impact strength, ductility (i.e.elongation at break), as well as other key properties which would be adversely affected in an incompatible alloy/blend, all suggest a favorable compatibility of the MBS modifier with the multipolymer matrix. The reason why clarity is maintained is because of refractive index matching between the modifier and the hard phase. The common methods of monomer blend composition control do not provide access to the range of 0.001 refractive index units, critical for the target optical properties. In the present invention, this high level of accuracy is achieved by a process of controlled feeding of auxiliary polymer additives that have different refractive index from and are miscible with the multipolymer hard phase.

It is possible to modify the Refractive Index (RI) of transparent acrylic plastics by means of mechanical blends of polymers of varying RI's. This can be used for RI adjustment of the acrylic resin to the target RI of the impact modifier. The method is useful in the following cases:

Compensation for process variation of acrylic resin RI

Compensation for impact modifier RI

Compensation for impact modifier RI changes due to extruder condition changes

Incompatibility is a common phenomenon in polymers and results in microphase separated opaque polymer blends. Miscibility of the polymer components of the matrix material is critical for the optical clarity in the current applications. For this reason, the auxiliary resins for RI adjustment are carefully designed to be completely miscible with the acrylic resin. They are acrylonitrile/styrene/acrylic copolymers of varied composition tuned to the desired refractive indices. The blends are prepared by feeding an extruder with precision loss-in-weight feeders which control the ratio of the base polymer and the RI modifying polymer. The overall RI can be approximated to the sum of RI contributions proportional to the volume fractions of the individual polymer components. Experimental work has shown that with proper comonomer selection, the RI of the basic acrylic resin can be adjusted within a relatively broad range, i.e., 1.49 to 1.60. Particular examples of-procedures for polymer preparation and processing that seeks to optimize RI match of the components, are set forth below.

In a first example, the base acrylic polymer is intentionally modified to optimize the RI match to the impact modifier. A 6″ diameter Welding Engineers, non-intermeshing, counter rotating, 36/L/D devolatilizing extruder was fed with an acrylic copolymer and impact modifier. The polymer was fed with a LUWA Vacurex 110/110 metering pump and the modifier with an Acrison 403 Loss-In-Weight (LIW) feeder with micro-date control. A portable Acrison 403 LIW was used to feed acrylic copolymers of high and low RI's optimizing the RI match.

A second example of this technique was carried out using a 50/1 L/D, 4½″ two stage, single double wave screw compounder. Three Technetic LIW feeders were used, one for the impact modifier, the second for the base acrylic copolymer and the third a tumble blend of the base polymer, additives and the RI modifying acrylic copolymer. This again, allowed an optimization of the RI match between the various phases.

| | |
|---|---|
| Novel | A combination of optical clarity surpassing the optical |
| Features: | properties of conventional polybutadiene impact modified |
| | acrylic compounds and retained impact strength at sub-zero |
| | temperatures, with particular strength measured at about 1 |
| | to 2 foot-pounds per inch. |
| Utility of | Improved appearance and color due to enhanced optical |
| Invention: | clarity. Applications in wider temperature range, as low as |
| | −80° F. |

The present invention will be better understood from a consideration of the following illustrative examples presenting formulations and their properties and characteristics, it being understood that the following are illustrative and not restrictive, and that all percentages are expressed in weight unless otherwise specified.

### EXAMPLES

The following compositions were prepared for use in the preparation of formed products that could be tested for optical and impact properties.

| | | |
|---|---|---|
| Formulation 1: | Terpolymer of methyl methacrylate, | 64.25% |
| | styrene and Ethyl acrylate | |
| | Kane-Ace B-564, supplied by Kaneka | 35% |
| | Texas Corp. | |
| | Plasticizing agent, stearyl alcohol | 0.4% |
| | Antioxidant, Irgafos 168 powder | 0.2% |
| | UV stabilizing agent, Tinuvin P | 0.15% |
| | Colorants for color matching, proprietary | |
| | composition | |
| Formulation 2: | Commercially available impact modified | |
| | acrylic molding and extrusion compounds, | |
| | comprising polymethylmethacrylate, methyl | |
| | acrylate, and butyl acrylate, with a BA | |
| | modifier comprising methyl | |
| | methacrylate, butyl acrylate and styrene, | |
| | with a representative composition | |
| | commercially available as ACRYLITE | |
| | PLUS ® | |
| | ZK-6 by CYRO Inds. | |
| Formulation 3: | Commercially available impact modified | |
| | acrylic molding and extrusion compounds, | |
| | comprising polymethylmethacrylate, ethyl | |
| | acrylate and styrene, and a MES modifier | |
| | comprising methyl acrylate, styrene and | |
| | butadiene, with a representative | |
| | composition commercially available | |
| | as CYROLITE G-20 HIFLO ® by CYRO | |
| | Inds. | |

The above formulations were used to prepare formed samples for testing as to optical and mechanical properties. The tests were conducted in accordance with known industry standards (ASTM), and the results are set forth in Table I, below.

TABLE I

| | ASTM Test | #1 | #2 | #3 |
|---|---|---|---|---|
| Optical Properties | | | | |
| Transmittance (%) | D1003 | 91 | 91.5 | 89 |
| Haze(%) | D1003 | 1.1 | 1.0 | 3.5 |
| Yellowness Index | D1003 | −2.0 | 0.4 | −0.5 |
| Mechanical Properties | | | | |
| Tensile Strength, psi | D 638 | 5500 | 6800 | 7,000 |
| Tensile Modulus, psi | D 638 | 240000 | 260000 | 370000 |
| Tensile Elongation | | | | |
| @ Yield (%) | D 638 | 4.0 | 5.0 | 3.8 |
| @ Break (%) | D 638 | 35 | 50 | 9.5 |
| Notched Izod, ft-lb/in | | | | |
| ¼″ bar @ 23° C. | D 256 | 1.5 | 1.0 | 1.9 |
| ¼″ bar @ 0° C. | D 256 | 1.2 | 0.6 | 1.1 |
| ¼″ bar @ −32° C. | D 256 | 1.0 | — | — |
| Rockwell Hardness (L) | D 785 | 45 | 35 | 27 |
| Rheological Properties | | | | |
| Melt Flow Index, g/10 min | | | | |
| @230° C., 5.0 kg | D1238 | 9 | — | 12 |
| @230° C., 3.8 kg | D1238 | — | 1.6 | — |

B. Examples of Applications

Acrylic based multipolymer molding and extrusion compositions may be prepared with particular ingredients and in the range of percentages as stated in claims (7), (8), (9), (10), (11), and (12) which are used in applications requiring toughness and transparency at low temperatures, including transparent mechanical tool handles; transparent refrigerator bins, shelves, or doors; medical filter housings; IV connectors; medical storage or treatment trays; dental treatment device handles; and commercial display shelves and components.

C. Chemical Compositions

Component A: acrylic based multipolymer as described above.

Component B: a high rubber graft copolymer, wherein said graft copolymer may comprise:

from 50 to 95 percent by weight of a conjugated diene polymeric substrate having a glass transition temperature below −60° C. An exemplary resin is an emulsion polymer of 1,3-butadiene.

from 5 to 50 percent by weight of a rigid superstrate copolymer having a glass transition temperature greater than or equal to 50° C. and consisting essentially of repeating units of a vinyl aromatic monomer and one or more (C₁-C₁₂) alkyl (meth)acrylate monomers, wherein at least a portion of the rigid superstrate is grafted onto the diene polymeric substrate. An exemplary grafted shell is the copolymer of methyl methacrylate and styrene with a low content of a cross-linking agent.

Components C&D: UV stabilizers, antioxidants, dyes etc. These are conventional additives used to enhance processability and certain performance parameters.

This invention may be embodied in other forms or carried out in other ways without departing from the spirit or essential characteristics thereof. The present disclosure is therefore to be considered as in all respects illustrative and not restrictive, the scope of the invention being indicated by the appended claims, and all changes which come within the meaning and range of equivalency are intended to be embraced therein.

What is claimed is:

1. An acrylic based multipolymer molding and extrusion composition possessing improved optical properties and low temperature impact resistance, comprising:
A) an acrylic based multipolymer, comprising in weight %: 8-12% acrylonitrile, 3-8% butyl acrylate, 3-5% ethyl acrylate, 3-8% methyl acrylate, 65-80% methyl methacrylate, and 15-30% styrene, said multipolymer present in an amount of from 55 to 85% by weight;
B) a methylmethacrylate-butadiene-styrene (MBS) copolymer modifier polymerized by a free radical process, said MBS copolymer modifier present in an amount of from 15 to 45% by weight;
C) a UV stabilizer, selected from the group consisting of benzotriazole derivatives, triazine derivatives, and hindered amine light stabilizers, and combinations thereof, said UV stabilizer present in an amount of up to about 0.5% by weight; and
D) one or more additives including antioxidants, dyes and plasticizing flow enhancers, such additives present in an amount of up to 5.0% by weight;
wherein said composition also possesses improved room temperature impact strength and optical clarity similar to that of unmodified acrylic resins.

2. The composition of claim 1, wherein the MBS impact modifier is comprised of several monomers within the following composition range, in % by weight: 50-90% 1,3-butadiene, 5-45% methyl methacrylate, and 3-15% styrene.

3. A process for preparing an acrylic based multipolymer molding and extrusion composition which comprises controlled feeding of auxiliary polymer additives that have different refractive indices from and are miscible with the multipolymer hard phase, to adjust the refractive index of the multipolymer hard phase to within 0.001 units and preferably 0.0005 units of the refractive index of the MBS modifier.

4. A process as in claim 3, wherein the compounding of the MBS modifier into the multipolymer hard phase and the feeding of the auxiliary polymers occurs in a single extrusion step.

5. An acrylic based multipolymer molding and extrusion composition as in either of claim 1 or 2, prepared with refractive index matching using auxiliary polymer additives, wherein the refractive index of the multipolymer hard phase is within about 0.001 units of the refractive index of the MBS modifier.

6. The composition of claim 5, wherein the auxiliary polymer additives have composition within the following range, in % by weight:

| | | |
|---|---|---|
| Formula A, Low refractive index: | methyl methacrylate | 92-98% |
| | methyl acrylate | 2-8% |
| Formula B, high refractive index | methyl methacrylate | 30-50% |
| | styrene | 45-70% |
| | acrylonitrile | 8-12% |
| | ethyl acrylate | 3-8% |

7. The composition of claim 5, containing up to 5% of lubricants, processing aids, and plasticisers.

8. The composition of claim 5, containing up to 0.5% of UV stabilizers.

9. The composition of claim 8, where the UV stabilizers are benzotriazole derivatives.

10. The composition of claim 9, wherein said benzotriazole derivatives are selected from the group consisting of 2-(2′-hydroxy-5′-methylphenyl) benzotriazole, triazine derivatives, e.g. 2-(4,6-diphenyl-1,3,5-triazine-2-yl)-5-hexyloxy)phenol, hindered amine light stabilizers, and combinations thereof.

11. The composition of claim 5, where the room temperature impact strength is retained to a commercially significant level at sub-zero temperatures, as low as −80° F.

12. An acrylic based multipolymer molding and extrusion composition possessing improved optical properties and low temperature impact resistance, comprising:
A) an acrylic based multipolymer, comprising a terpolymer of methyl methacrylate, styrene and ethyl acrylate in an amount of 64.25% by weight;
B) a methylmethacrylate-butadiene-styrene (MBS) copolymer modifier polymerized by a free radical process, said MBS copolymer modifier present in an amount of 35% by weight;
C) an antioxidant in an amount of up to about 0.4% by weight; and
D) a plasticizing agent in an amount of 0.4% by weight;
wherein said composition also possesses improved room temperature impact strength and optical clarity similar to that of unmodified acrylic resins.

13. The composition of either of claim 1 or 12, wherein the composition contains a rubber phase, and the average particle size of said rubber phase is at least 50 nm.

14. The composition of either of claim 1 or 12, wherein the composition contains a rubber phase, and the average particle size of said rubber phase is on the order of about 100 nm.
